(19) United States
(12) Patent Application Publication
(10) Pub. No.: US 2023/0419637 A1
(43) Pub. Date: Dec. 28, 2023

(54) METHOD, DEVICE, AND STORAGE MEDIUM FOR KEY POINT OR JOINT KEY POINT DETECTION AND MODEL TRAINING

(71) Applicant: Alibaba (China) Co., Ltd., Hangzhou (CN)

(72) Inventors: Wei LIU, Hangzhou (CN); Yu WANG, Hangzhou (CN); Le LU, Bethesda, MD (US); Xiansheng HUA, Hangzhou (CN)

(21) Appl. No.: 18/048,196

(22) Filed: Oct. 20, 2022

(30) Foreign Application Priority Data
Jun. 22, 2022 (CN) 202210716065.0

(51) Int. Cl. G06V 10/46; G06V 10/77; G06T 3/40

(52) U.S. Cl. CPC G06V 10/462; G06V 10/7715; G06T 3/4007

(57) ABSTRACT

A method for key point detection includes the following steps: acquiring an image to be recognized; and inputting the image to be recognized into a trained key point detection model to obtain a target heat map output by the key point detection model, the target heat map corresponding to key points in the image to be recognized. The key point detection model is configured to determine a first heat map of a first size and a second heat map of a second size corresponding to the key points in the image to be recognized and correct the second heat map according to the first heat map to obtain the target heat map; the first size being smaller than the second size.

### CROSS-REFERENCE TO RELATED APPLICATIONS

The present application claims priority to and the benefits of Chinese Patent Application Serial No. 202210716065.0, filed on Jun. 22, 2022, which is incorporated herein by reference in its entirety.

### TECHNICAL FIELD

The present disclosure relates to the field of computer technologies, and in particular, to a key point or a joint key point detection, a model training, a device, and a storage medium.

### BACKGROUND

At present, there are two types of key point detection solutions. The first type is based on a conventional machine learning method, which uses a predefined feature extraction method to obtain features of each pixel or region of an image, and then performs classification or regression to the features to locate key points. The second type is based on a deep learning method. Instead of designing features manually, a deep neural network is used for extracting effective features directly from an image to predict positions of key points.

However, the existing key point detection solutions have a low accuracy of locating key points.

### SUMMARY

Embodiments of the present disclosure provide a method for key point detection. The method includes: acquiring an image to be recognized; and inputting the image to be recognized into a trained key point detection model to obtain a target heat map output by the key point detection model, the target heat map corresponding to key points in the image to be recognized. The key point detection model is configured to: determine a first heat map of a first size and a second heat map of a second size corresponding to the key points in the image to be recognized; and correct the second heat map according to the first heat map to obtain the target heat map, the first size being smaller than the second size.

Embodiments of the present disclosure provide a method for training a model. The method includes: acquiring a sample image and a first expected heat map of a first size and a second expected heat map of a second size corresponding to key points in the sample image, the first size being smaller than the second size; inputting the sample image to a key point detection model to obtain a target predicted heat map corresponding to the key points in the sample image output by the key point detection model; wherein the key point detection model is configured to determine a first predicted heat map of the first size and a second predicted heat map of the second size corresponding to the key points in the sample image and configured to correct the second predicted heat map according to the first predicted heat map to obtain the target predicted heat map; and optimizing the key point detection model according to a difference between the first predicted heat map and the first expected heat map and a difference between the target predicted heat map and the second expected heat map.

Embodiments of the present disclosure provide a method for joint key point detection. The method includes acquiring a medical image to be recognized related to human bone joints; and inputting the medical image to be recognized into a trained key point detection model to obtain a target heat map output by the key point detection model, the target heat map corresponding to bone joint key points in the medical image to be recognized. The key point detection model is configured to determine a first heat map of a first size and a second heat map of a second size corresponding to the bone joint key points in the medical image to be recognized, and configured to correct the second heat map according to the first heat map to obtain the target heat map, the first size being smaller than the second size.

Embodiments of the present disclosure provide an electronic device. The electronic device includes a memory configured to store a program; and one or more processors coupled to the memory and configured to execute the program stored in the memory to cause the electronic device to perform one of the methods above.

Embodiments of the present disclosure provide a non-transitory computer-readable storage medium. The non-transitory computer-readable storage medium stores a set of instructions that are executable by one or more processors of a device to cause the device to perform one of the methods above.

It should be understood that the above general descriptions and the following detailed descriptions are merely for exemplary and explanatory purposes, and do not limit the present disclosure.

### BRIEF DESCRIPTION OF THE DRAWINGS

To describe the technical solutions in the embodiments of the present disclosure or the prior art more clearly, the accompanying drawings required for describing the embodiments or the prior art are briefly introduced as follows. Apparently, the accompanying drawings described in the following are merely some embodiments in the present disclosure, and a person of ordinary skill in the art may still derive other drawings from these accompanying drawings without creative efforts.

FIG. 1 is a schematic flow chart of a method for key point detection according to some embodiments of the present disclosure;

FIG. 2 is a schematic flow chart of internal processing of a key point detection model according to some embodiments of the present disclosure;

FIG. 3 is a schematic flow chart of a method for training a model according to some embodiments of the present disclosure;

FIG. 4 is a schematic flow chart of a method for joint key point detection according to some embodiments of the present disclosure;

FIG. 5 is a schematic flow chart of a method for key point detection according to some embodiments of the present disclosure;

FIG. 6 is a schematic diagram of an annotated image according to some embodiments of the present disclosure;

FIG. 7A is a schematic flow chart of internal processing of a key point detection model according to some embodiments of the present disclosure;

FIG. 7B is a schematic flow chart of a method for joint key point detection according to some embodiments of the present disclosure; and

FIG. 8 is a structural block diagram of an electronic device according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

Knee joints are important weight-bearing joints in lower extremity of a human body and are also the most complex joints in the human body. As the years of use increase, incidence of degenerative osteoarthritis of knee joints is increasing year by year. The reported incidence of symptomatic osteoarthritis of knee joints is 35% for males and as high as 74% for females over the age of 50. With the acceleration of population aging in China, more and more patients need artificial knee replacement. Total knee arthroplasty (TKA) is an effective treatment for knee arthritis, which can relieve the pain of knee joints and improve the functions of knee joints. However, an accurate and thorough preoperative planning is critical to the success of the TKA. For the preoperative planning, a patient first needs to stand on an X-ray imaging table and take a full-length film of the lower extremity under load. After taking the X-ray, the doctor needs to observe lines of force of the patient's lower extremity and the severity of knee arthritis, including measuring some anatomical parameters such as a joint line convergence angle (JLCA), hip-knee-ankle angle (HKA), and anatomical-mechanical axis (AMA) angle. The most critical measurement is to find bony landmarks, that is, key points, on which these anatomical parameters dependent on the X-ray film. The accuracy of locating these key points directly determines the accuracy of preoperative planning and the success of the operation. With these key points, the doctor can calculate these anatomical parameters, evaluate a knee joint status of the patient, and then select a corresponding surgical treatment method and an appropriate size of an artificial prosthesis. Currently, the preoperative planning for the TKA is done manually by doctors, which is laborious and time-consuming.

Among existing anatomical key point detection methods, the method based on conventional machine learning only uses local information on an image due to the use of manually designed features, and the detection accuracy is often low. The method based on deep learning can directly extract effective features from an image, and the learning ability of a deep neural network is stronger, which can obtain higher locating accuracy than the conventional machine learning method.

However, existing deep learning key point locating methods are basically experimented on natural images, and do not pursue high locating accuracy.

In order to improve the locating accuracy of key points of a key point detection model, a method for key point detection is provided in some embodiments of the present disclosure. That is, a key point detection model is used for learning a first heat map and a second heat map with different sizes, and the second heat map with a larger size is corrected based on the first heat map with a smaller size to obtain a more accurate heat map. In this way, the locating accuracy of key points can be improved.

To make those skilled in the art better understand the solutions in the present disclosure, the technical solutions in the embodiments of the present disclosure will be clearly and completely described in the following with reference to the accompanying drawings in the embodiments of the present disclosure. It is apparent that the embodiments described are merely some of rather than all the embodiments of the present disclosure. Based on the embodiments of the present disclosure, all other embodiments derived by a person skilled in the art without any creative effort shall all fall within the protection scope of the present disclosure.

Furthermore, some of the processes described in the specification, claims, and drawings of the present disclosure contain operations occurring in a specific order, and these operations may be performed not in the order they are presented herein or may be performed in parallel. Sequence numbers of the operations, such as 101 and 102, are only used for distinguishing different operations, and the sequence numbers themselves do not represent any execution order. Additionally, these processes may include more or fewer operations, and these operations may be performed sequentially or in parallel. It should be noted that the descriptions such as “first” and “second” herein are used for distinguishing different messages, devices, modules, and the like, and do not represent a sequence, nor do they limit “first” and “second” are different types.

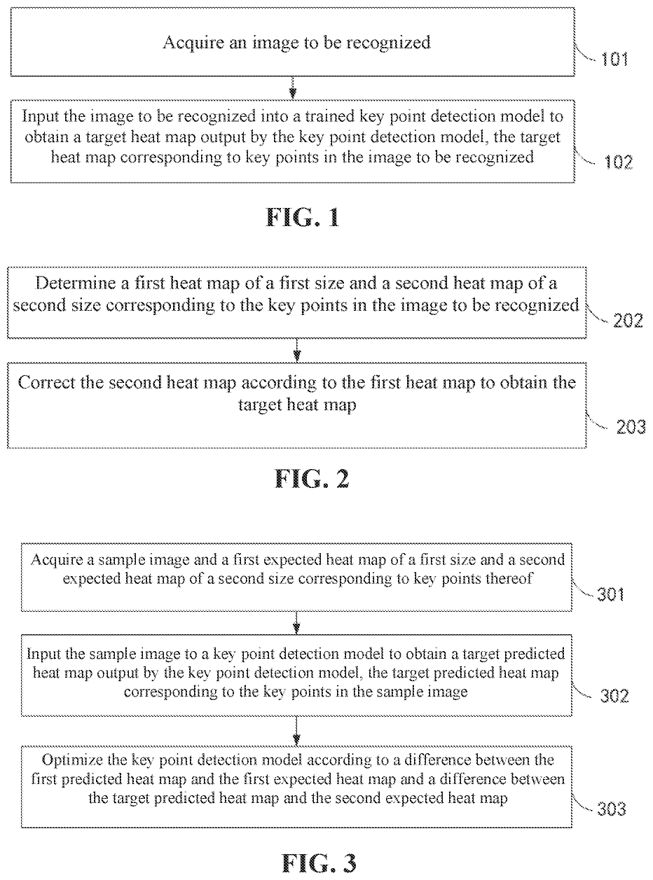

FIG. 1 is a schematic flow chart of a method for key point detection according to some embodiments of the present disclosure. An executing entity of the method can be a client or a server. The client may be a piece of hardware with an embedded program integrated on a terminal, or may be application software installed in the terminal, or may be tool software embedded in a terminal operating system, or the like, which is not limited in the embodiments of the present disclosure. The terminal may be any terminal device including a mobile phone, a tablet computer, and the like. The server may be a common server, a cloud or a virtual server, and the like, which is not specifically limited in the embodiments of the present disclosure. As shown in FIG. 1, the method includes following steps 101 and 102.

In step 101, an image to be recognized is acquired.

In step 102, the image to be recognized is input into a trained key point detection model to obtain a target heat map output by the key point detection model. The target heat map corresponds to key points in the image to be recognized.

As shown in FIG. 2, the key point detection model is configured to perform the following steps 201 and 202.

In step 201, a first heat map of a first size and a second heat map of a second size are determined. The first heat map and the second heat map correspond to the key points in the image to be recognized.

In step 202, the second heat map is corrected according to the first heat map to obtain the target heat map.

The first size is smaller than the second size.

In the above step 101, in different application scenarios, the above images to be recognized may be images of different types. For example, in a human body key point detection scenario, the above image to be recognized may be a human body image to be recognized, and key points thereof may be human body key points. As another example, in a human face key point detection scenario, the above image to be recognized may be a human face image to be recognized, and key points thereof may be human face key points. As yet another example, in a bone joint key point detection scenario, the above image to be recognized may be a medical image to be recognized related to bone joints, and key points thereof may be bone joint key points.

In a practical application, the size of an original image to be recognized may not meet input size requirements of a key point detection model. Therefore, the original image to be recognized needs to be scaled to obtain the above image to be recognized that meets the input size requirements. The above scaling process may be uniform scaling, or may be non-uniform scaling.

In the above step 102, the above key point detection model may be a machine learning model. Specifically, the above key point detection model may be a deep learning model, such as a neural network model.

In the above step 201, the above key point detection model obtains the first heat map and the second heat map through learning.

The quantity of key points in the image to be recognized may be one or more than one, and each key point corresponds to a first heat map of a first size and a second heat map of a second size.

A value of each pixel in the first heat map of the first size or the second heat map of the second size corresponding to each key point may be used for representing the probability that the pixel corresponds to the key point. The value range of the probability may be [0, 1]. Generally, it may be considered that the position of the pixel with the highest probability is the position of the key point in the heat map.

In a practical application, with the computational cost and convergence rate during training taken into account, the size of the first heat map (i.e., the first size) and the size of the second heat map (i.e., the second size) are both smaller than the size of the image to be recognized. For example, the size of the first heat map is ¼ of the size of the image to be recognized, and the size of the second heat map is ½ of the size of the image to be recognized. In this way, the quantity of model parameters of the key point detection model can be effectively reduced, thereby reducing the computational cost, and improving the convergence rate during training.

In the above step 202, the second heat map is corrected according to the first heat map. That is, a low-resolution heat map and a high-resolution heat map are fused, so that the locating of key points is more accurate.

The size of the target heat map is the same as the size of the second heat map.

In the technical solutions provided by the embodiments of the present disclosure, a key point detection model is used for learning a first heat map and a second heat map with different sizes, and the second heat map with a larger size is corrected based on the first heat map with a smaller size to obtain a more accurate heat map. In this way, the locating accuracy of key points can be improved.

In an achievable solution, the operation of “determining a first heat map of a first size and a second heat map of a second size corresponding to the key points in the image to be recognized” in the above step 201 may be implemented by adopting the following steps 2011 and 2012.

In step 2011, feature extraction is performed on the image to be recognized to obtain a first feature map of the first size.

In step 2012, the first heat map of the first size and the second heat map of the second size corresponding to the key points in the image to be recognized are determined according to the first feature map.

In the above step 2011, generally speaking, the size of the first feature map is smaller than the size of the image to be recognized.

A data form of the first feature map is: W*H*C, where W is the width of the first feature map, H is the height of the first feature map, W*H is the size of the first feature map, and C is the number of channels of the first feature map. C may be an integer greater than or equal to 1.

When the key point detection model is a deep learning-based neural network model, the above key point detection model may include a feature extraction network. The feature extraction network is configured to perform feature extraction on the image to be recognized to obtain the first feature map of the image to be recognized. In an example, the above feature extraction network may include a Convolutional Neural Network (CNN). Extracting features through a convolutional neural network can improve the effectiveness of the feature extraction.

In the above step 2012, the first heat map of the first size and the second heat map of the second size corresponding to the key points in the image to be recognized are determined according to the first feature map. In a practical application, different convolutional processing may be performed according to the first feature map to obtain the first heat map of the first size and the second heat map of the second size.

In one example, the size of the first feature map is the first size. In the above step 2012, the operation of “determining, according to the first feature map, the first heat map of the first size and the second heat map of the second size corresponding to the key points in the image to be recognized” may be implemented by adopting the following steps S10, S11, and S12.

In step S10, the first heat map of the first size is determined according to the first feature map.

In step S11, a transposed convolution is performed on the first feature map to obtain a second feature map of the second size.

In step S12, the second heat map of the second size is determined according to the second feature map.

In the above step S10, a convolutional processing may be performed on the first feature map without changing the size, so as to obtain the first heat map of the first size. The size of a convolution kernel of the above convolution operation may be 1*1.

In the above step S11, specifically, a transposed convolution processing may be performed on the first feature map by using a transposed convolutional layer, so as to obtain the second feature map of the second size. Network parameters of the transposed convolutional layer are obtained by training and learning. In other words, the second feature map is obtained by learning the first feature map, not by performing linear interpolation on the first feature map. The semantic expression ability of the second feature map can be improved, thereby improving the locating accuracy of the second heat map.

In the above step S12, a convolutional processing may be performed on the second feature map without changing the size, so as to obtain the second heat map of the second size. The size of the convolution kernel used in the convolution processing may be 1*1, so that the size of the feature map will not be changed.

Optionally, the operation of “correcting the second heat map according to the first heat map to obtain the target heat map” in the above step 202 may be implemented by adopting the following steps 2021 and 2022.

In step 2021, a linear interpolation is performed on the first heat map to obtain an interpolated heat map of the second size.

In step 2022, the second heat map is corrected according to the interpolated heat map to obtain the target heat map.

In the above step 2021, that is, a two-dimensional linear interpolation is performed on the first heat map to obtain an interpolated heat map of the second size. For the specific implementation of the linear interpolation, reference may be made to the existing technologies and details are not described herein. The size of the obtained interpolated heat map is consistent with the size of the second heat map, that is, the second size.

In the above step 2022, in an achievable solution, the interpolated heat map and the second heat map may be added element-wise to obtain an added heat map. The target heat map is determined according to the added heat map.

The element-wise addition refers to adding, at the corresponding position, each element of the two heat maps.

In another achievable solution, the interpolated heat map and the second heat map may be multiplied element-wise to obtain a multiplied heat map, and the target heat map is determined according to the multiplied heat map.

The element-wise multiplication refers to multiplying, at the corresponding position, each element of the two heat maps.

In one example, the added heat map or the multiplied heat map may be directly used as the target heat map.

In another example, a convolution operation may be performed on the added heat map or the multiplied heat map to obtain the target heat map. Distribution of heat values of the multiplied heat map and the added heat map does not meet Gaussian distribution, and therefore, a convolution processing using a 1*1 convolution kernel can make output results as close as possible to the Gaussian distribution.

A training process of the key point detection model according to the embodiments of the present disclosure will be introduced below. The method may further include the following steps 103, 104, and 105.

In step 103, a sample image and a first expected heat map of the first size and a second expected heat map of the second size corresponding to key points of the sample image are acquired.

In step 104, the sample image is input into the key point detection model to obtain the target predicted heat map output by the key point detection model. The target predicted heat map corresponds to key points in the sample image.

The key point detection model is configured to determine a first predicted heat map of the first size and a second predicted heat map of the second size corresponding to the key points in the sample image, and correct the second predicted heat map according to the first predicted heat map to obtain the target predicted heat map.

In step 105, the key point detection model is optimized according to a difference between the first predicted heat map and the first expected heat map and a difference between the target predicted heat map and the second expected heat map.

The size of the above first predicted heat map is relatively small, and compared with the second predicted heat map, it is relatively easier to train a branch in the model that predicts the first predicted heat map and converges faster. The size of the second predicted heat map is relatively large, and it is relatively more difficult to train a branch in the model that predicts the second predicted heat map and converges slower. Therefore, by correcting the second predicted heat map based on the first predicted heat map, it is equivalent to providing an additional supervision signal for the branch training of the second predicted heat map based on the first predicted heat map, which can accelerate the convergence and improve the training performance.

In the above step 103, in different application scenarios, the above sample images may be sample images of different types. For example, in a human body key point detection scenario, the above sample image may be a human body sample image, and key points thereof may be human body key points. As another example, in a human face key point detection scenario, the above sample image may be a human face sample image, and key points thereof may be human face key points. As yet another example, in a bone joint key point detection scenario, the above sample image may be a medical sample image related to bone joints, and key points thereof may be bone joint key points.

The quantity of key points in the sample image may be one or more than one, where each key point corresponds to a first expected heat map of a first size and a second expected heat map of a second size. The above first expected heat map and second expected heat map may be understood as heat map labels of the sample image.

The value of each pixel in the first expected heat map of the first size or the second expected heat map of the second size corresponding to each key point may be used for representing the real probability that the pixel corresponds to the key point. The value range of the probability may be [0, 1]. Generally, it may be considered that the position of the pixel with the highest probability is the position of the key point in the heat map.

In the above step 104, the size of the target predicted heat map is the same as the size of the second predicted heat map. The sample image is input to the key point detection model so that the key point detection model performs the following steps 1041 and 1042.

In step 1041, the first predicted heat map of the first size and the second predicted heat map of the second size corresponding to the key points in the sample image are determined.

In step 1042, the second predicted heat map is corrected according to the first predicted heat map to obtain the target predicted heat map.

In an achievable solution, the operation of “determining the first predicted heat map of the first size and the second predicted heat map of the second size corresponding to the key points in the sample image” in the above step 1041 may be implemented by adopting the following steps S21 and S22.

In step S21, a feature extraction is performed on the sample image to obtain a first sample feature map of the first size.

In step S22, the first predicted heat map of the first size and the second predicted heat map of the second size corresponding to the key points in the sample image are determined according to the first sample feature map.

In the above step S21, the size of the first sample feature map is consistent with the size of the first feature map. Generally speaking, the size of the first sample feature map is smaller than the size of the image to be recognized.

A data form of the first sample feature map is: W*H*C, where W is the width of the first sample feature map, H is the height of the first sample feature map, W*H is the size of the first sample feature map, and C is the number of channels of the first sample feature map. C may be an integer greater than or equal to 1.

When the key point detection model is a deep learning-based neural network model, the above key point detection model may include a feature extraction network. The feature extraction network is configured to perform feature extraction on the sample image to obtain the first feature map of the sample image. In an example, the above feature extraction network may include a convolutional neural network. Extracting features through the convolutional neural network can improve the effectiveness of the feature extraction.

In the above step S22, the first sample heat map of the first size and the second sample heat map of the second size corresponding to the key points in the sample image are determined according to the first sample feature map. In a practical application, different convolutional processing may be performed according to the first sample feature map to obtain the first sample heat map of the first size and the second sample heat map of the second size.

In one example, the size of the first sample feature map is the first size. In the above step S22, the operation of “determining, according to the first sample feature map, the first predicted heat map of the first size and the second predicted heat map of the second size corresponding to the key points in the sample image” may be implemented by adopting the following steps S220, S221, and S222.

In step S220, the first predicted heat map of the first size is determined according to the first sample feature map.

In step S221, a transposed convolution is performed on the first sample feature map to obtain a second sample feature map of the second size.

In step S222, the second predicted heat map of the second size is determined according to the second sample feature map.

In the above step S220, a convolutional layer processing may be performed on the first sample feature map without changing the size, so as to obtain the first predicted heat map of the first size.

In the above step S221, specifically, a transposed convolution processing may be performed on the first sample feature map by using a transposed convolutional layer, so as to obtain the second sample feature map of the second size.

In the above step S222, a convolutional processing may be performed on the second sample feature map without changing the size, so as to obtain the second predicted heat map of the second size. The size of the convolution kernel used in the convolution processing may be 1*1, so that the size of the feature map will not be changed.

In the above step 1042, the second predicted heat map is corrected according to the first predicted heat map to obtain the target predicted heat map.

Optionally, the operation of “correcting the second predicted heat map according to the first predicted heat map to obtain the target predicted heat map” in the above step 1042 may be implemented by adopting the following steps S31 and S32.

In step S31, a linear interpolation is performed on the first predicted heat map to obtain an interpolated predicted heat map of the second size.

In step S32: the second predicted heat map is corrected according to the interpolated predicted heat map to obtain the target predicted heat map.

In the above step S31, that is, a two-dimensional linear interpolation is performed on the first predicted heat map to obtain an interpolated predicted heat map of the second size. For the specific implementation of the linear interpolation, reference may be made to existing technologies and details are not described herein. The size of the obtained interpolated predicted heat map is consistent with the size of the second predicted heat map, that is, the second size.

In the above step S32, in an achievable solution, the interpolated predicted heat map and the second predicted heat map may be added element-wise to obtain the added predicted heat map. The target predicted heat map is determined according to the added predicted heat map.

The element-wise addition refers to adding, at the corresponding position, each element of the two heat maps.

In another achievable solution, the interpolated predicted heat map and the second predicted heat map may be multiplied element-wise to obtain a multiplied predicted heat map, and the target predicted heat map is determined according to the multiplied predicted heat map.

The element-wise multiplication refers to multiplying, at the corresponding position, each element of the two heat maps.

In one example, the added heat map or the multiplied heat map may be directly used as the target heat map.

In another example, a convolution operation may be performed on the added predicted heat map or the multiplied predicted heat map to obtain the target predicted heat map. Distribution of heat values of the multiplied predicted heat map and the added predicted heat map does not meet Gaussian distribution, and therefore, a convolution processing using a 1*1 convolution kernel can make output results as close as possible to the Gaussian distribution.

It should be noted that element-wise multiplication is more beneficial for model training than element-wise addition, because the value ranges of the interpolated predicted heat map and the second predicted heat map are both [0, 1], the value of the heat map obtained by addition becomes larger as a whole, while the multiplication reduces the value of the heat map, which has higher requirements on the model and is beneficial for training the model better.

In the above step 105, the key point detection model is optimized according to the difference between the first predicted heat map and the first expected heat map and the difference between the target predicted heat map and the second expected heat map.

A first loss value may be determined according to the difference between the first predicted heat map and the first expected heat map. A second loss value may be determined according to the difference between the target predicted heat map and the second expected heat map. The first loss value and the second loss value are weighted and summed to obtain a total loss value. The key point detection model is optimized based on the total loss value. The optimization process may be performed by a gradient descent algorithm or a first-order optimization algorithm, and the specific implementation may be obtained with reference to the existing technologies, which will not be repeated herein for brevity.

The above first loss value Lossₗ and second loss value Lossₕ may be calculated using the following formula:

$${Loss}_{l} = \frac{1}{N} {\sum }_{i}^{N} {\sum }_{j}^{M} {( {H}_{l ( i , j )}^{pred} - {H}_{l ( i , j )}^{gt} )}^{2} \qquad ( 1 )$$

$${Loss}_{h} = \frac{1}{N} {\sum }_{i}^{N} {\sum }_{j}^{M} {( {H}_{h ( i , j )}^{pred} - {H}_{h ( i , j )}^{gt} )}^{2} \qquad ( 2 )$$

The first loss value Lossₗ and the second loss value Lossₕ are defined by a mean-square error (MSE) function. N is the batch size of network training. M is a total quantity of key points in the sample image. H_{*}^{Pred} and H_{*}^{gt} are the corresponding predicted heat map and the corresponding expected heat map, respectively.

In an example, the total loss value may be calculated using the following formula:

Loss=Lossₗ+Lossₕ (3)

An expected heat map generation method based on unbiased coding is introduced below, which avoids the impact on the training effect of the key point detection model caused due to an error by rounding non-integer key point coordinates obtained by mapping, thereby improving the locating accuracy of key points. Specifically, the above method may further include the following steps 106 and 107.

In step 106, products of a quotient of dividing the first size by a size of the sample image and coordinates of the key points in the sample image are determined as coordinates of the key points in the first expected heat map.

In step 107, the first expected heat map is generated according to the determined coordinates of the key points in the first expected heat map.

In the above step 106, generally, the quotient of dividing the first size by the size of the sample image is a decimal less than 1, so the product of the quotient and the coordinates of a key point in the sample image may be a non-integer. In the existing technologies, this product is usually rounded to serve as the coordinates of the key point in the expected heat map, which will inevitably introduce an error. In the above embodiments, the above product is not rounded, but is rather directly used as the coordinates of the key point in the first expected heat map. In other words, in the above embodiments, the coordinates of the key point in the first expected heat map may not correspond to a certain pixel in the first expected heat map, but rather correspond to a certain sub pixel in the first expected heat map.

In the above step 107, in an achievable solution, the first expected heat map that meets the two-dimensional Gaussian distribution is generated according to the determined coordinates of the key points in the first expected heat map. That is, a first expected heat map that obeys the two-dimensional Gaussian distribution with a position parameter μ as the coordinates of the determined key points in the first expected heat map and a scale parameter σ is generated. Values of pixels outside the Gaussian distribution range (−3σ to 3σ) in the first expected heat map may be 0. The value of the scale parameter σ may be set according to actual needs.

Further, the above method may further include the following steps 108 and 109.

In step 108, products of a quotient of dividing the second size by the size of the sample image and the coordinates of the key points in the sample image are determined as coordinates of the key points in the second expected heat map.

In step 109, the second expected heat map is generated according to the determined coordinates of the key points in the second expected heat map.

In the above step 108, generally, the quotient of dividing the second size by the size of the sample image is a decimal less than 1, so the product of the quotient and the coordinates of a key point in the sample image may be a non-integer. In the existing technologies, this product is usually rounded to serve as the coordinates of the key point in the expected heat map, which will inevitably introduce an error. In the above embodiments, the above product is not rounded, but is rather directly used as the coordinates of the key point in the second expected heat map. In other words, in the above embodiments, the coordinates of the key point in the second expected heat map may not correspond to a certain pixel in the second expected heat map, but rather correspond to a certain sub pixel in the second desired heat map.

In the above step 109, in an achievable solution, the second expected heat map that meets the two-dimensional Gaussian distribution is generated according to the determined coordinates of the key points in the second expected heat map. That is, a second expected heat map that obeys the two-dimensional Gaussian distribution with a position parameter μ as the coordinates of the determined key points in the second expected heat map and a scale parameter σ is generated. Values of pixels outside the Gaussian distribution range (−3σ to 3σ) in the second expected heat map may be 0. The value of the scale parameter σ may be set according to actual needs.

Assuming that the coordinates of the key points in the sample image are (pₓ′, p_{y}′), the formula for generating the first expected heat map is:

Hₗ^{gt}(x,y)=exp[−½σ²((x−(pₓ′*q₁))²+(y−(p_{y}′*q₁))²)] (4)

The formula for generating the second expected heat map is as follows:

Hₕ^{gt}(x,y)=exp[−½σ²((x−(pₓ′*q₂))²+(y−(p_{y}′*q₂))²)] (5)

The exp( ) in the formula denotes the natural exponential function. σ denotes a variance (i.e., the scale parameter), and the value may be 2. q₁ and q₂ are respectively the quotient of dividing the first size by the size of the sample image and the quotient of dividing the second size by the size of the sample image.

It should be additionally noted that, in order to improve the correction effect of the high-resolution heat map based on the low-resolution heat map, both the above first expected heat map and the second expected heat map may be generated by the above unbiased encoding heat map generation method. In this way, the deviation in the correction due to the error of any one of the expected heat maps may be avoided.

Generally, the size of the directly collected image does not meet the input size required by the key point detection model. Therefore, the above method may further include the following steps 110, 111, 112, and 113.

In step 110, an initial image is acquired.

Key points in the initial image are annotated.

In step 111, an input size required by the key point detection model is acquired.

In step 112, a scaling processing is performed on the initial image to obtain the sample image whose size is the input size.

In step 113, the products of a quotient of dividing the input size by the size of the initial image and coordinates of the key points in the initial image is determined as the coordinates of the key points in the sample image.

In the above step 110, the key points in the initial image are annotated, and coordinates of the key points in the initial image are annotated.

In the above step 112, when the input size is larger than the size of the initial image, the initial image is enlarged. When the input size is smaller than the size of the initial image, the initial image is reduced.

In the above step 113, a quotient of dividing the input size by the size of the initial image may be an integer or a decimal. In other words, the products of the quotient and the coordinates of the key points in the initial image may be decimals. In the embodiments of the present disclosure, the product is directly used as the coordinates of the key point in the sample image, and subsequent processing is performed based on the determined coordinates of the key point in the sample image.

Taking into account the practical application, in order to obtain a sample image with the size of the input size, the initial image needs to be scaled non-uniformly, that is, the scaling ratios in the two dimensions of width and height are different. Therefore, the quotient of dividing the input size by the size of the original sample image thus includes: a first quotient in the width dimension and a second quotient in the height dimension. Assuming that the coordinates of the key points in the sample image are (pₓ′, p_{y}′), and the coordinates of the key points in the original sample image are (pₓ, p_{y}), both of which meet the following formula:

(pₓ′,p_{y}′)=(pₓ*sₓ,p_{y}*s_{y}) (6)

sₓ and s_{y} are the first quotient on the width dimension and the second quotient on the height dimension, respectively.

In a practical application, after the target heat map output by the key point detection model is obtained, coordinate decoding may also be performed based on the target heat map to determine the coordinates of the key points in the image to be recognized. In other words, the above method may further include the following step 114.

In step 114, the coordinates of the key points of the image to be recognized are determined through coordinate decoding according to the heat map.

In one example, a target pixel with the greatest heat value in the target heat map may be determined, and the coordinates of the key point in the image to be recognized may be determined according to coordinates of the target pixel in the target heat map and the ratio of the size of the image to be recognized to the size of the target heat map.

Considering that the expected heat map generation method of the unbiased encoding is adopted in the embodiments of the present disclosure, the coordinates of the key points in the final predicted target heat map may not correspond to the target pixel with the greatest heat value in the heat map, but rather correspond to another sub pixel close to the target pixel in the heat map.

In order to improve the locating accuracy, the operation of “determining the coordinates of the key points of the image to be recognized through coordinate decoding according to the heat map” in the above step 114 may be implemented by using the following steps 1141, 1142, and 1143.

In step 1141, a target pixel with the greatest heat value in the target heat map is determined.

In step 1142, potential peak coordinates in the target heat map are determined, according to coordinates of the target pixel in the target heat map and distribution statistics of the target heat map at the target pixel.

In step 1143, coordinates of the key point in the image to be recognized are determined, according to the product of the quotient of dividing the size of the image to be recognized by the size of the target heat map and the potential peak coordinates.

In the above step 1141, the distribution statistics of the target heat map at the target pixel may include a first-order derivative and a second-order derivative of the target heat map at the target pixel. The potential peak coordinates in the target heat map may be determined using the Taylor formula. Assuming that the coordinates of the target pixel in the target heat map are (xₘ, yₘ), the following formula may be used to calculate the potential peak coordinates (x_{z}, y_{z}):

$$( {x}_{z} , {y}_{z} ) = ( {x}_{m} - \frac{D ( {x}_{m} )}{H ( {x}_{m} )} , {y}_{m} - \frac{D ( {y}_{m} )}{H ( {y}_{m} )} ) \qquad ( 7 )$$

D(xₘ), H(xₘ), H(yₘ), and D(yₘ) are in sequence the first-order derivative and the second-order derivative of the target heat map in the width direction at the target pixel, and the first-order derivative and the second-order derivative of the target heat map in the height direction at the target pixel. xₘ is a coordinate value of the key point in the width direction, and yₘ is a coordinate value of the key point in the height direction.

The following formula may be used to calculate the coordinates p(x*, y*) of the key point in the image to be recognized:

p(x*,y*)=(x_{z},y_{z})×Q (8)

Q is the quotient of dividing the size of the image to be recognized by the size of the target heat map.

In addition, in practical applications, after the coordinates of the key point in the image to be recognized are obtained, according to the coordinates of the key point in the image to be recognized and the first and second quotients above, the coordinates of the key point in the original image to be recognized may be determined. The coordinates of the key point in the original image to be recognized may be determined by using the following formula:

p(x^{o},y^{o})=round(x*/sₓ,y*/s_{y}) (9)

In the formula, round( ) is a rounding function, and definitions of sₓ and s_{y} may be obtained with reference to the corresponding content above.

A schematic flow chart of a method for model training is provided in some embodiments of the present disclosure. As shown in FIG. 3, the method includes the following steps 301, 302, and 303.

In step 301, a sample image and a first expected heat map of the first size and a second expected heat map of the second size corresponding to key points thereof are acquired.

The first size is smaller than the second size.

In step 302, the sample image is input into the key point detection model to obtain the target predicted heat map corresponding to key points in the sample image output by the key point detection model.

The key point detection model is configured to determine a first predicted heat map of the first size and a second predicted heat map of the second size corresponding to the key points in the sample image, and correct the second predicted heat map according to the first predicted heat map to obtain the target predicted heat map.

In step 303, the key point detection model is optimized according to a difference between the first predicted heat map and the first expected heat map and a difference between the target predicted heat map and the second expected heat map.

Specific implementations of above step 301 to step 303 may be obtained with reference to the related content in the above embodiments, which are not repeated herein for brevity.

Optionally, the method may further include the following steps 304, 305, 306, and 307.

In step 304, products of a quotient of dividing the first size by a size of the sample image and coordinates of the key points in the sample image are determined as coordinates of the key points in the first expected heat map.

In step 305, the first expected heat map is generated according to the determined coordinates of the key points in the first expected heat map.

In step 306, products of a quotient of dividing the second size by the size of the sample image and the coordinates of the key points in the sample image is determined as coordinates of the key points in the second expected heat map.

In step 307, the second expected heat map is generated according to the determined coordinates of the key points in the second expected heat map.

Specific implementations of above step 304 to step 307 may be obtained with reference to the related content in the above embodiments, which are not repeated herein for brevity.

It should be noted here that, for the content not described in detail in each step of the method provided in the embodiments of the present disclosure, reference may be made to the corresponding content in the foregoing embodiments, and details are not repeated herein for brevity. Further, in addition to the above steps, the methods provided in the embodiments of the present disclosure may also include some or all of the other steps in the above embodiments. For details, reference may be made to the corresponding contents of the above embodiments, which will not be repeated herein for brevity.

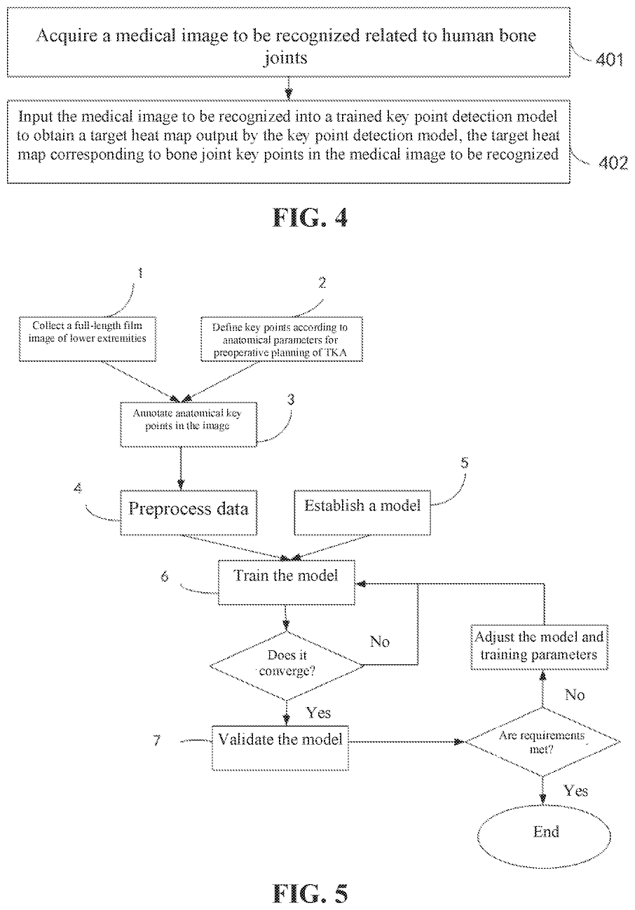

The above key point detection method may be applied to a bone joint key point detection scenario. Specifically, a method for joint key point detection is further provided in some embodiments of the present disclosure. As shown in FIG. 4, the method includes the following steps 401 and 402.

In step 401, a medical image to be recognized related to human bone joints is acquired.

In step 402, the medical image to be recognized is input into a trained key point detection model to obtain a target heat map output by the key point detection model. The target heat map corresponds to bone joint key points in the medical image to be recognized.

The key point detection model is configured to determine a first heat map of a first size and a second heat map of a second size corresponding to the bone joint key points in the medical image to be recognized and correct the second heat map according to the first heat map to obtain the target heat map. The first size is smaller than the second size.

It should be noted here that, for the content not described in detail in each step of the method provided in the embodiments of the present disclosure, reference may be made to the corresponding content in the foregoing embodiments, and details are not repeated herein for brevity. Further, in addition to the above steps, the methods provided in the embodiments of the present disclosure may also include some or all of the other steps in the above embodiments. For details, reference may be made to the corresponding contents of the above embodiments, which will not be repeated herein for brevity.

The embodiments of the present disclosure provide an unbiased coordinate encoding method. Secondly, the coordinates of key points are regressed on a higher-resolution heat map (½ of the size of the input image), and a contextual attention mechanism is introduced between the high-resolution heat map and the low-resolution heat map, which makes the key point locating more accurate, and is more in line with the requirements of the automatic measurement of TKA preoperative planning.

The key point detection solution provided by the embodiments of the present disclosure will be described in detail below by taking a bone joint key point detection scenario as an example. As shown in FIG. 5, the solution includes the following steps 1-7.

In step 1, a full-length film image of lower extremities is collected.

A full-length X-ray lower extremity film of knee joints may be acquired, and an image that meets requirements may be selected.

In step 2, key points required for measurement is defined according to anatomical parameters required for the preoperative planning of Total Knee Arthroplasty (TKA).

In step 3, image anatomical key points are annotated.

The collected images are annotated according to the key points defined in step 2.

In step 4, a data preprocessing is performed.

Window widths, window levels, and sizes of all collected images are unified, and the same transformation is performed on the coordinates of the annotated key points according to transformation relationships of image sizes, and a corresponding expected heat map is generated with the transformed coordinates as the center. The preprocessed data can be divided into training dataset and testing dataset.

In step 5, a model is established.

A key point detection model for full-length films of lower extremities based on a deep neural network is built.

In step 6, the model is trained.

The model is trained by using a preprocessed training dataset until the model converges.

In step 7, the model is validated.

Validation is performed with the testing dataset by using the converged model to determine whether the requirement of the accurate locating is met. If the requirement is not met, the model and training parameters are adjusted, and the model is retrained. If the requirement is met, the training ends.

The collection of full-length film images of the lower extremities in step 1 may be divided into the following steps.

First, X-ray images of the full-length films of the lower extremities are selected.

Second, a second review of the selected result in the above first step is performed to filter out erroneous and invalid images.

Third, key points required for measurement is defined according to anatomical parameters required for the preoperative planning of TKA.

The operation of defining the corresponding key points according to anatomical parameters required for preoperative planning of TKA in the step 2 is specifically divided into the following steps.

First, the anatomical parameters required for measurement for the preoperative planning of TKA is determined. The anatomical parameters include, but not limited to, a Joint Line Congruency Angle (JLCA), a Hip-Knee-Ankle angle (HKA), a Femoral Anatomic Mechanical Angle (FAMA), a Tibia Anatomic Mechanical Angle (TAMA), an anatomical Lateral Distal Femoral Angle (aLDFA), a mechanical Lateral Distal Femoral Angle (mLDFA), anatomical Medial Proximal Tibial Angle (aMPTA), mechanical Medial Proximal Tibia Angle (mMPTA), and the like.

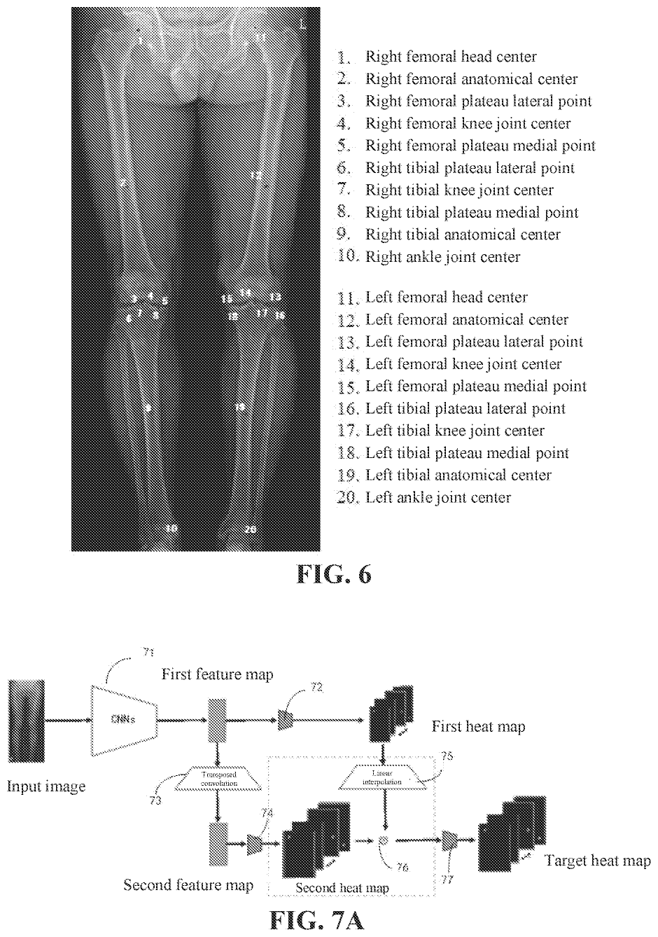

Second, according to the anatomical parameters, anatomical key points on the femur and acetabulum are defined, as shown in FIG. 6.

The left lower extremity and the right lower extremity are symmetrical, and 10 anatomical key points are defined therein respectively. A total of 20 anatomical key points are as follows, in which numbers in parentheses are corresponding serial numbers.

Key points on the right lower extremity include: the center of the right femoral head (1), the anatomical center of the right femoral (2), the lateral point of the right femoral plateau (3), the knee joint center of the right femoral (4), the medial point of the right femoral plateau (5), the lateral point of the right tibial plateau (6), the knee joint center of the right tibial (7), the medial point of the right tibial plateau (8), the anatomical center of the right tibial (9), and the center of the right ankle joint (10).

Key points on the left lower extremity include: the center of the left femoral head (11), the anatomical center of the left femoral (12), the lateral point of the left femoral plateau (13), the knee joint center of the left femoral (14), the medial point of the left femoral plateau (15), the lateral point of the left tibial plateau (16), the knee joint center of the left tibial (17), the medial point of the left tibial plateau (18), the anatomical center of the left tibial (19), and the center of the left ankle joint (20).

Third, anatomical key points are annotated in the image.

The images collected in step 1 are annotated according to the 20 key points defined on the full-length films of the lower extremities in step 2. Two professional orthopedic surgeons perform the annotation independently, and then a senior orthopedic specialist reviews the annotation to judge ambiguous annotation results.

Fourth, the data is preprocessed.

Window widths, window levels, and sizes of all collected images are unified, and the same transformation is performed on the coordinates of the annotated key points according to transformation relationships of image sizes, and a corresponding expected heat map is generated by using the transformed coordinates. The preprocessed data can be divided into a training dataset and a testing dataset.

The step is specifically divided into the following steps.

First, the window width and window level of all images are unified to 4095 HU and 2047 HU.

An image having the imaging type of “Monochrome1” is converted to a “Monochrome2” type through grayscale conversion. Then, the window width and window level are adjusted.

Second, scaling is performed to the original image I₁ to uniformly scale it to the size of 640×320, obtain image data I₂ required for the model training, and record a scaling factor s:

I₂=s×I₁ (10)

The scaling factor s includes: a first quotient sₓ in the width dimension and a second quotient s_{y} in the height dimension as mentioned above.

Third, according to the image preprocessing step of the second step above, the same transformation is made to the coordinates of the key points annotated on the original image to obtain the corresponding coordinates on the I₂ image. The transformation formula is as follows:

pⁱⁿ=p^{gt}×s (11)

In the formula, p^{gt}=(pₓ, p_{y}) is the coordinates annotated on the original image. pⁱⁿ=(pₓ′, p_{y}′) is the converted coordinates, corresponding to the two directions (or dimensions) of width and height. The conversion relationship is:

pₓ′=pₓ×sₓ (12)

p_{y}′=p_{y}×s_{y} (13)

Fourth, according to the new key point coordinates pⁱⁿ obtained in the third step above, a low-resolution expected heat map Hᵢ^{gt} (corresponding to the first expected heat map above) and a high-resolution expected heat map Hₕ^{gt} (corresponding to the second expected heat map above) are generated, which obey a two-dimensional Gaussian distribution.

The specific generation formula may be obtained with reference to the related content in the foregoing, and are not repeated herein for brevity.

One heat map is generated for each anatomical key point, that is, at most 20 low-resolution heat maps and 20 high-resolution heat maps are generated from one X-ray image. Different from other methods, the coordinates of c₁ are not rounded here, but instead, decimals are retained, and thus an unbiased heat map is generated.

Fifth, a model is established.

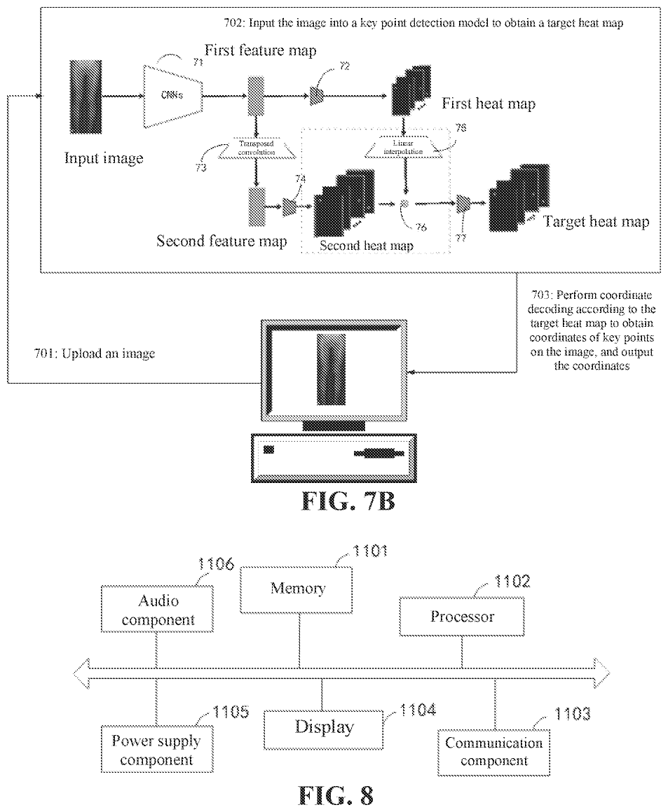

A key point detection model is built by using a deep convolutional neural network. As shown in FIG. 7A, this operation is divided into the following steps 71-77.

In step 71, a first feature map Fₗ of low resolution (e.g., ¼ size), with the size of 32×160×80, is obtained first after the preprocessed image are input through the convolutional neural networks (CNNs).

In step 72, after passing through a 1×1 convolutional layer (1×1 cony), a first heat map Hₗ of low resolution (¼ size), with the size of 20×160×80, is output.

In step 73, after the first feature map Fₗ of low resolution (¼ size) passes through a 1×1 transposed convolutional layer (Deconv), a second feature map Fₕ of high resolution (½ size), with the size of 32×320×160, is obtained.

In step 74, after passing through the 1×1 convolutional layer, a second heat map Hₕ′, of high resolution (½ size), with the size of 20×320×160, is output.

In step 75, linear interpolation is performed on the first heat map Hₗ of low resolution (¼ size) and is expanded to the same size as the second heat map Hₕ′ of high resolution (½ size).

In step 76, a result obtained after the linear interpolation of the step 75 is element-wise multiplied with the second heat map Hₕ′ of high-resolution (½ size).

In step 77, after passing through a 1×1 convolutional layer, a final target heat map Hₕ of high resolution is output.

Sixth, the model is trained.

80% of the preprocessed images and annotated data obtained in the step 4 are used as a training set to train and optimize the model established in the step 5. The loss function used may be obtained with reference to the corresponding content above, and will not be repeated in detail here.

The model may be iteratively optimized using the Adam algorithm (a first-order optimization algorithm) with an initial learning rate of 0.001 and a total of 200 iterations. The learning rate drops to 0.0001 at the 120th iteration and to 0.00001 at the 170th iteration. During training, some data augmentation operations are used to expand the training data and avoid model overfitting The data augmentation operations may include: left-right flipping (with a probability of 0.5), random scaling (0.5 to 1.5 times), and random rotation (−45° to +45°). Training is performed until the model converges to obtain an optimized model.

Seventh, the model is validated.

The remaining 20% of the images and annotated data obtained in the step 4 are used as a testing set to test the optimized model. The specific steps are as follows.

First, according to a high-resolution heat map Hₕ output by the model, coordinates of predicted anatomical key points in the original image are obtained through coordinate decoding.

Assuming that the coordinates of the target pixel with the greatest value on the heat map Hₕ are (xₘ^{pred}, yₘ^{pred}), the potential peak coordinates on the heat map Hₕ are:

$$( {x}_{z}^{pred} , {y}_{z}^{pred} ) = ( {x}_{m}^{pred} - \frac{D ( {x}_{m}^{pred} )}{H ( {x}_{m}^{pred} )} , {y}_{m}^{pred} - \frac{D ( {y}_{m}^{pred} )}{H ( {y}_{m}^{pred} )} ) \qquad ( 14 )$$

D(xₘ^{pred}), H(xₘ^{pred}), H(yₘ^{pred}), and D(yₘ^{pred}) are in sequence the first-order derivative and the second-order derivative of the heat map Hₕ in the width direction at the target pixel, and the first-order derivative and the second-order derivative of the heat map Hₕ in the height direction at the target pixel. Then, the coordinates of the key points in the sample image are:

p^{pred}(x*y*)=(x_{z}^{pred}×2y_{z}^{pred}×2) (15)

The coordinates of the key points in the original image may be calculated by using the following formula:

p_{pred}(x^{o},y^{o})=round(x*/sₓ,y*/s_{y}) (16)

In the formula, round( ) is a rounding function, and definitions of sₓ and s_{y} may be obtained with reference to the corresponding content above.

Second, a mean radial error (MRE) is used to evaluate a detection effect of the model on anatomical key points:

$$MRE = \frac{1}{N} {\sum }_{i}^{N} {\sum }_{j = 1}^{M} {R}_{ij} = \frac{1}{N} {\sum }_{i}^{N} {\sum }_{j = 1}^{M} {( {p}_{ij}^{pred} - {p}_{ij}^{gt} )}^{2} \qquad ( 17 )$$

In the formula, N is the number of test images, M is the total number of key points, R is the Euclidean distance, and pᵢⱼ^{pred} and pᵢⱼ^{gt} are the coordinates of the j-th key point predicted on the i-th test image and the corresponding annotated key point coordinates. In the experiment, the criteria are that the MRE is less than 2 pixels. If the criteria are met, the model optimization is completed. If the criteria are not met, the procedure returns to the step 6 to adjust the model and training parameters, and restart the training until the criteria are met.

A detection scheme for bone joint key points will be explained below as an example with reference to FIG. 7B.

In step 701, an image to be recognized is uploaded through a computer.

In step 702, the image is input into a key point detection model to obtain a target heat map.

The above step 702 may be specifically divided into multiple steps to be performed, and for details, reference can be made to the relevant description of FIG. 7A.

In step 703, coordinate decoding is performed according to the target heat map to obtain coordinates of key points on the image, and the coordinates are output to the computer for display to a user by the computer.

In some embodiments, the key point detection method is used to solve the problem of automatic measurement of TKA preoperative planning. An unbiased coordinate encoding method is used to correct an error caused by scaling a convolutional neural network feature map. A low-resolution key point heat map and a high-resolution key point heat map are fused using a contextual attention method, so that key point locating is more accurate and meets clinical requirements.

FIG. 8 is a schematic structural diagram of an electronic device according to some embodiments of the present disclosure. As shown in FIG. 8, the electronic device includes a memory 1101 and a processor 1102. The memory 1101 may be configured to store various other data to support operations on the electronic device. Examples of such data include instructions for any application or method to operate on the electronic device. The memory 1101 may be implemented by any type of volatile or non-volatile storage device or a combination thereof, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk, or an optical disc.

The memory 1101 is configured to store a program.

The processor 1102, coupled to the memory 1101, is configured to execute the program stored in the memory 1101, so as to implement the methods provided by the foregoing method embodiments.

Further, as shown in FIG. 8, the electronic device further includes a communication component 1103, a display 1104, a power supply component 1105, an audio component 1106, and other components. While only some components are shown in FIG. 8, it does not mean that the electronic device only includes the components shown in FIG. 8.

Correspondingly, the embodiments of the present disclosure further provide A non-transitory computer-readable storage medium storing a computer program, and when the computer program is executed by a computer, the steps or functions of the methods provided by the foregoing method embodiments can be implemented.

The apparatus embodiments described above are only explanatory, where the units described as separate components may or may not be physically separated, and the components displayed as units may or may not be physical units. That is, these components may be located in one place, or may be distributed in a plurality of network units. Part or all of the modules may be selected according to actual needs to achieve the purpose of the solution of the present embodiments. Those of ordinary skill in the art may understand and implement the solution of the present embodiments without creative effort.

Through the description of the implementations above, those skilled in the art can clearly understand that the various implementations may be implemented by means of software plus a necessary general hardware platform, and may also be implemented by hardware. Based on such understanding, the above technical solution essentially, or the portion contributing to the prior art may be embodied in the form of a software product. The computer software product may be stored in A non-transitory computer-readable storage medium, such as a ROM/RAM, a magnetic disk, or an optical disc, and include several instructions that enable a computer device (which may be a personal computer, a server, or a network device) to perform the methods in the embodiments or certain portions of the embodiments.

The embodiments may further be described using the following clauses:
1. A method for key point detection, comprising:
   acquiring an image to be recognized; and
   inputting the image to be recognized into a trained key point detection model to obtain a target heat map output by the key point detection model, the target heat map corresponding to key points in the image to be recognized;
   wherein the key point detection model is configured to: determine a first heat map of a first size and a second heat map of a second size corresponding to the key points in the image to be recognized; and correct the second heat map according to the first heat map to obtain the target heat map, the first size being smaller than the second size.
2. The method of clause 1, wherein the determining the first heat map of the first size and the second heat map of the second size corresponding to the key points in the image to be recognized comprises:
   performing feature extraction on the image to be recognized to obtain a first feature map of the first size;
   determining, according to the first feature map, the first heat map of the first size corresponding to the key points in the image to be recognized;
   performing transposed convolution on the first feature map to obtain a second feature map of the second size; and
   determining the second heat map of the second size according to the second feature map.
3. The method of clause 1 or 2, wherein the correcting the second heat map according to the first heat map to obtain the target heat map comprises:
   performing linear interpolation on the first heat map to obtain an interpolated heat map of the second size; and
   correcting the second heat map according to the interpolated heat map to obtain the target heat map.
4. The method of clause 3, wherein the correcting the second heat map according to the interpolated heat map to obtain the target heat map comprises:
   performing element-wise multiplication to the interpolated heat map and the second heat map to obtain a multiplied heat map; and
   determining the target heat map according to the multiplied heat map.
5. The method of any of clauses 1-4, further comprising:
   acquiring a sample image and a first expected heat map of the first size and a second expected heat map of the second size corresponding to key points in the sample image;
   inputting the sample image to the key point detection model to obtain a target predicted heat map output by the key point detection model, the target predicted heat map corresponding to the key points in the sample image; wherein the key point detection model is configured to determine a first predicted heat map of the first size and a second predicted heat map of the second size corresponding to the key points in the sample image, and configured to correct the second predicted heat map according to the first predicted heat map to obtain the target predicted heat map, wherein the key point detection model is a machine learning model; and
   optimizing the key point detection model according to a difference between the first predicted heat map and the first expected heat map and a difference between the target predicted heat map and the second expected heat map.
6. The method of clause 5, further comprising:
   determining products of a quotient of dividing the first size by a size of the sample image and coordinates of the key points in the sample image as coordinates of the key points in the first expected heat map; and
   generating the first expected heat map according to the determined coordinates of the key points in the first expected heat map.
7. The method of clause 6, further comprising:
   determining products of a quotient of dividing the second size by the size of the sample image and the coordinates of the key points in the sample image as coordinates of the key points in the second expected heat map; and
   generating the second expected heat map according to the determined coordinates of the key points in the second expected heat map.
8. The method of clause 6 or 7, further comprising:
   acquiring an initial image, key points in the initial image being annotated;
   acquiring an input size required by the key point detection model;
   performing scaling processing on the initial image to obtain the sample image with the input size; and
   determining products of a quotient of dividing the input size by the size of the initial image and coordinates of the key points in the initial image as coordinates of the key points in the sample image.
9. The method of any of clauses 1-8, further comprising:
   determining a target pixel with the greatest heat value in the target heat map;
   determining, according to coordinates of the target pixel in the target heat map and distribution statistics of the target heat map at the target pixel, potential peak coordinates in the target heat map; and
   determining, according to products of a quotient of dividing a size of the image to be recognized by a size of the target heat map and the potential peak coordinates, coordinates of the key points in the image to be recognized.
10. A method for training a model, comprising:
   acquiring a sample image and a first expected heat map of a first size and a second expected heat map of a second size corresponding to key points in the sample image, the first size being smaller than the second size;
   inputting the sample image to a key point detection model to obtain a target predicted heat map corresponding to the key points in the sample image output by the key point detection model; wherein the key point detection model is configured to determine a first predicted heat map of the first size and a second predicted heat map of the second size corresponding to the key points in the sample image and configured to correct the second predicted heat map according to the first predicted heat map to obtain the target predicted heat map; and
   optimizing the key point detection model according to a difference between the first predicted heat map and the first expected heat map and a difference between the target predicted heat map and the second expected heat map.
11. The method of clause 10, further comprising:
   determining products of a quotient of dividing the first size by a size of the sample image and coordinates of the key points in the sample image as coordinates of the key points in the first expected heat map;
   generating the first expected heat map according to the determined coordinates of the key points in the first expected heat map;
   determining products of a quotient of dividing the second size by the size of the sample image and the coordinates of the key points in the sample image as coordinates of the key points in the second expected heat map; and
   generating the second expected heat map according to the determined coordinates of the key points in the second expected heat map.
12. A method for joint key point detection, comprising:
   acquiring a medical image to be recognized related to human bone joints; and
   inputting the medical image to be recognized into a trained key point detection model to obtain a target heat map output by the key point detection model, the target heat map corresponding to bone joint key points in the medical image to be recognized;
   wherein the key point detection model is configured to determine a first heat map of a first size and a second heat map of a second size corresponding to the bone joint key points in the medical image to be recognized, and configured to correct the second heat map according to the first heat map to obtain the target heat map, the first size being smaller than the second size.
13. An electronic device, comprising:
   a memory configured to store a program; and
   one or more processors coupled to the memory and configured to execute the program stored in the memory to cause the electronic device to perform:
      acquiring an image to be recognized; and
      inputting the image to be recognized into a trained key point detection model to obtain a target heat map output by the key point detection model, the target heat map corresponding to key points in the image to be recognized;
      wherein the key point detection model is configured to: determine a first heat map of a first size and a second heat map of a second size corresponding to the key points in the image to be recognized; and correct the second heat map according to the first heat map to obtain the target heat map, the first size being smaller than the second size.
14. The electronic device of clause 13, wherein the key point detection model is configured to determine the first heat map of the first size and the second heat map of the second size corresponding to the key points in the image to be recognized by:
   performing feature extraction on the image to be recognized to obtain a first feature map of the first size;
   determining, according to the first feature map, the first heat map of the first size corresponding to the key points in the image to be recognized;
   performing transposed convolution on the first feature map to obtain a second feature map of the second size; and
   determining the second heat map of the second size according to the second feature map.
15. The electronic device of clause 13 or 14, wherein the key point detection model is configured to correct the second heat map according to the first heat map to obtain the target heat map by:
   performing linear interpolation on the first heat map to obtain an interpolated heat map of the second size; and
   correcting the second heat map according to the interpolated heat map to obtain the target heat map.
16. The electronic device of clause 15, wherein the key point detection model is further configured to correct the second heat map according to the interpolated heat map to obtain the target heat map by:
   performing element-wise multiplication to the interpolated heat map and the second heat map to obtain a multiplied heat map; and
   determining the target heat map according to the multiplied heat map.
17. The electronic device of any of clauses 13-16, wherein the one or more processors are configured to execute the program to cause the electronic device to further perform:
   acquiring a sample image and a first expected heat map of the first size and a second expected heat map of the second size corresponding to key points in the sample image;
   inputting the sample image to the key point detection model to obtain a target predicted heat map output by the key point detection model, the target predicted heat map corresponding to the key points in the sample image; wherein the key point detection model is configured to determine a first predicted heat map of the first size and a second predicted heat map of the second size corresponding to the key points in the sample image, and configured to correct the second predicted heat map according to the first predicted heat map to obtain the target predicted heat map, wherein the key point detection model is a machine learning model; and
   optimizing the key point detection model according to a difference between the first predicted heat map and the first expected heat map and a difference between the target predicted heat map and the second expected heat map.
18. The electronic device of clause 17, wherein the one or more processors are configured to execute the program to cause the electronic device to further perform:
   determining products of a quotient of dividing the first size by a size of the sample image and coordinates of the key points in the sample image as coordinates of the key points in the first expected heat map; and
   generating the first expected heat map according to the determined coordinates of the key points in the first expected heat map.
19. The electronic device of clause 18, wherein the one or more processors are configured to execute the program to cause the electronic device to further perform:
   determining products of a quotient of dividing the second size by the size of the sample image and the coordinates of the key points in the sample image as coordinates of the key points in the second expected heat map; and
   generating the second expected heat map according to the determined coordinates of the key points in the second expected heat map.
20. The electronic device of clause 18 or 19, wherein the one or more processors are configured to execute the program to cause the electronic device to further perform:
   acquiring an initial image, key points in the initial image being annotated;
   acquiring an input size required by the key point detection model;
   performing scaling processing on the initial image to obtain the sample image with the input size; and
   determining products of a quotient of dividing the input size by the size of the initial image and coordinates of the key points in the initial image as coordinates of the key points in the sample image.
21. The electronic device of any of clauses 13-20, wherein the one or more processors are configured to execute the program to cause the electronic device to further perform:
   determining a target pixel with the greatest heat value in the target heat map;
   determining, according to coordinates of the target pixel in the target heat map and distribution statistics of the target heat map at the target pixel, potential peak coordinates in the target heat map; and
   determining, according to products of a quotient of dividing a size of the image to be recognized by a size of the target heat map and the potential peak coordinates, coordinates of the key points in the image to be recognized.
22. An electronic device, comprising:
   a memory configured to store a program; and
   one or more processors coupled to the memory and configured to execute the program stored in the memory to cause the electronic device to perform:
      acquiring a sample image and a first expected heat map of a first size and a second expected heat map of a second size corresponding to key points in the sample image, the first size being smaller than the second size;
      inputting the sample image to a key point detection model to obtain a target predicted heat map corresponding to the key points in the sample image output by the key point detection model; wherein the key point detection model is configured to determine a first predicted heat map of the first size and a second predicted heat map of the second size corresponding to the key points in the sample image and configured to correct the second predicted heat map according to the first predicted heat map to obtain the target predicted heat map; and
      optimizing the key point detection model according to a difference between the first predicted heat map and the first expected heat map and a difference between the target predicted heat map and the second expected heat map.
23. The electronic device of clause 22, wherein the one or more processors are configured to execute the program to cause the electronic device to further perform:
   determining products of a quotient of dividing the first size by a size of the sample image and coordinates of the key points in the sample image as coordinates of the key points in the first expected heat map;
   generating the first expected heat map according to the determined coordinates of the key points in the first expected heat map;
   determining products of a quotient of dividing the second size by the size of the sample image and the coordinates of the key points in the sample image as coordinates of the key points in the second expected heat map; and
   generating the second expected heat map according to the determined coordinates of the key points in the second expected heat map.
24. An electronic device, comprising:
   a memory configured to store a program; and
   one or more processors coupled to the memory and configured to execute the program stored in the memory to cause the electronic device to perform:
      acquiring a medical image to be recognized related to human bone joints; and
      inputting the medical image to be recognized into a trained key point detection model to obtain a target heat map output by the key point detection model, the target heat map corresponding to bone joint key points in the medical image to be recognized;
      wherein the key point detection model is configured to determine a first heat map of a first size and a second heat map of a second size corresponding to the bone joint key points in the medical image to be recognized, and configured to correct the second heat map according to the first heat map to obtain the target heat map, the first size being smaller than the second size.
25. A non-transitory computer-readable storage medium storing a set of instructions that are executable by one or more processors of a device to cause the device to perform a method for key point detection, the method comprising:
   acquiring an image to be recognized; and
   inputting the image to be recognized into a trained key point detection model to obtain a target heat map output by the key point detection model, the target heat map corresponding to key points in the image to be recognized;
   wherein the key point detection model is configured to: determine a first heat map of a first size and a second heat map of a second size corresponding to the key points in the image to be recognized; and correct the second heat map according to the first heat map to obtain the target heat map, the first size being smaller than the second size.
26. The non-transitory computer-readable storage medium of clause 25, wherein the set of instructions are executable by the one or more processors of the device to cause the device to further perform to determine the first heat map of the first size and the second heat map of the second size corresponding to the key points in the image to be recognized by:
   performing feature extraction on the image to be recognized to obtain a first feature map of the first size;
   determining, according to the first feature map, the first heat map of the first size corresponding to the key points in the image to be recognized;
   performing transposed convolution on the first feature map to obtain a second feature map of the second size; and
   determining the second heat map of the second size according to the second feature map.
27. The non-transitory computer-readable storage medium of clause 25 or 26, wherein the set of instructions are executable by the one or more processors of the device to cause the device to further perform to correct the second heat map according to the first heat map to obtain the target heat map by:
   performing linear interpolation on the first heat map to obtain an interpolated heat map of the second size; and
   correcting the second heat map according to the interpolated heat map to obtain the target heat map.
28. The non-transitory computer-readable storage medium of clause 27, wherein the set of instructions are executable by the one or more processors of the device to cause the device to further perform to correct the second heat map according to the interpolated heat map to obtain the target heat map by:
   performing element-wise multiplication to the interpolated heat map and the second heat map to obtain a multiplied heat map; and
   determining the target heat map according to the multiplied heat map.
29. The non-transitory computer-readable storage medium of any of clauses 25-28, wherein the set of instructions are executable by the one or more processors of the device to cause the device to further perform:
   acquiring a sample image and a first expected heat map of the first size and a second expected heat map of the second size corresponding to key points in the sample image;
   inputting the sample image to the key point detection model to obtain a target predicted heat map output by the key point detection model, the target predicted heat map corresponding to the key points in the sample image; wherein the key point detection model is configured to determine a first predicted heat map of the first size and a second predicted heat map of the second size corresponding to the key points in the sample image, and configured to correct the second predicted heat map according to the first predicted heat map to obtain the target predicted heat map, wherein the key point detection model is a machine learning model; and
   optimizing the key point detection model according to a difference between the first predicted heat map and the first expected heat map and a difference between the target predicted heat map and the second expected heat map.
30. The non-transitory computer-readable storage medium of clause 29, wherein the set of instructions are executable by the one or more processors of the device to cause the device to further perform:
   determining products of a quotient of dividing the first size by a size of the sample image and coordinates of the key points in the sample image as coordinates of the key points in the first expected heat map; and
   generating the first expected heat map according to the determined coordinates of the key points in the first expected heat map.
31. The non-transitory computer-readable storage medium of clause 30, wherein the set of instructions are executable by the one or more processors of the device to cause the device to further perform:
   determining products of a quotient of dividing the second size by the size of the sample image and the coordinates of the key points in the sample image as coordinates of the key points in the second expected heat map; and
   generating the second expected heat map according to the determined coordinates of the key points in the second expected heat map.
32. The non-transitory computer-readable storage medium of clause 30 or 31, wherein the set of instructions are executable by the one or more processors of the device to cause the device to further perform:
   acquiring an initial image, key points in the initial image being annotated;
   acquiring an input size required by the key point detection model;
   performing scaling processing on the initial image to obtain the sample image with the input size; and
   determining products of a quotient of dividing the input size by the size of the initial image and coordinates of the key points in the initial image as coordinates of the key points in the sample image.
33. The non-transitory computer-readable storage medium of any of clauses 25-32, wherein the set of instructions are executable by the one or more processors of the device to cause the device to further perform:
   determining a target pixel with the greatest heat value in the target heat map;
   determining, according to coordinates of the target pixel in the target heat map and distribution statistics of the target heat map at the target pixel, potential peak coordinates in the target heat map; and
   determining, according to products of a quotient of dividing a size of the image to be recognized by a size of the target heat map and the potential peak coordinates, coordinates of the key points in the image to be recognized.
34. A non-transitory computer-readable storage medium storing a set of instructions that are executable by one or more processors of a device to cause the device to perform a method for training a model, the method comprising:
   acquiring a sample image and a first expected heat map of a first size and a second expected heat map of a second size corresponding to key points in the sample image, the first size being smaller than the second size;
   inputting the sample image to a key point detection model to obtain a target predicted heat map corresponding to the key points in the sample image output by the key point detection model; wherein the key point detection model is configured to determine a first predicted heat map of the first size and a second predicted heat map of the second size corresponding to the key points in the sample image and configured to correct the second predicted heat map according to the first predicted heat map to obtain the target predicted heat map; and
   optimizing the key point detection model according to a difference between the first predicted heat map and the first expected heat map and a difference between the target predicted heat map and the second expected heat map.
35. The non-transitory computer-readable storage medium of clause 34, wherein the set of instructions are executable by the one or more processors of the device to cause the device to further perform:
   determining products of a quotient of dividing the first size by a size of the sample image and coordinates of the key points in the sample image as coordinates of the key points in the first expected heat map;
   generating the first expected heat map according to the determined coordinates of the key points in the first expected heat map;
   determining products of a quotient of dividing the second size by the size of the sample image and the coordinates of the key points in the sample image as coordinates of the key points in the second expected heat map; and
   generating the second expected heat map according to the determined coordinates of the key points in the second expected heat map.
36. A non-transitory computer-readable storage medium storing a set of instructions that are executable by one or more processors of a device to cause the device to perform a method for joint key point detection, the method comprising:
   acquiring a medical image to be recognized related to human bone joints; and
   inputting the medical image to be recognized into a trained key point detection model to obtain a target heat map output by the key point detection model, the target heat map corresponding to bone joint key points in the medical image to be recognized;
   wherein the key point detection model is configured to determine a first heat map of a first size and a second heat map of a second size corresponding to the bone joint key points in the medical image to be recognized, and configured to correct the second heat map according to the first heat map to obtain the target heat map, the first size being smaller than the second size.

Finally, it should be noted that, the above embodiments are merely used for describing the technical solution of the present disclosure, and do not limit the present disclosure. Although the present disclosure is described in detail with reference to the foregoing embodiments, persons of ordinary skill in the art should understand that they can still make modifications on the technical solution provided in the above embodiments, or perform equivalent replacements on a part of technical features thereof. These modifications or replacements are not intended to make the essences of the corresponding technical solutions depart from the spirit and scope of the technical solutions of the embodiments of the present disclosure.

1. A method for key point detection, comprising:
acquiring an image to be recognized; and
inputting the image to be recognized into a trained key point detection model to obtain a target heat map output by the key point detection model, the target heat map corresponding to key points in the image to be recognized;
wherein the key point detection model is configured to: determine a first heat map of a first size and a second heat map of a second size corresponding to the key points in the image to be recognized; and correct the second heat map according to the first heat map to obtain the target heat map, the first size being smaller than the second size.

2. The method of claim 1, wherein the determining the first heat map of the first size and the second heat map of the second size corresponding to the key points in the image to be recognized comprises:
performing feature extraction on the image to be recognized to obtain a first feature map of the first size;
determining, according to the first feature map, the first heat map of the first size corresponding to the key points in the image to be recognized;
performing transposed convolution on the first feature map to obtain a second feature map of the second size; and
determining the second heat map of the second size according to the second feature map.

3. The method of claim 1, wherein the correcting the second heat map according to the first heat map to obtain the target heat map comprises:
performing linear interpolation on the first heat map to obtain an interpolated heat map of the second size; and
correcting the second heat map according to the interpolated heat map to obtain the target heat map.

4. The method of claim 3, wherein the correcting the second heat map according to the interpolated heat map to obtain the target heat map comprises:
performing element-wise multiplication to the interpolated heat map and the second heat map to obtain a multiplied heat map; and
determining the target heat map according to the multiplied heat map.

5. The method of claim 1, further comprising:
acquiring a sample image and a first expected heat map of the first size and a second expected heat map of the second size corresponding to key points in the sample image;
inputting the sample image to the key point detection model to obtain a target predicted heat map output by the key point detection model, the target predicted heat map corresponding to the key points in the sample image; wherein the key point detection model is configured to determine a first predicted heat map of the first size and a second predicted heat map of the second size corresponding to the key points in the sample image, and configured to correct the second predicted heat map according to the first predicted heat map to obtain the target predicted heat map, wherein the key point detection model is a machine learning model; and
optimizing the key point detection model according to a difference between the first predicted heat map and the first expected heat map and a difference between the target predicted heat map and the second expected heat map.

6. The method of claim 5, further comprising:
determining products of a quotient of dividing the first size by a size of the sample image and coordinates of the key points in the sample image as coordinates of the key points in the first expected heat map; and
generating the first expected heat map according to the determined coordinates of the key points in the first expected heat map.

7. The method of claim 6, further comprising:
determining products of a quotient of dividing the second size by the size of the sample image and the coordinates of the key points in the sample image as coordinates of the key points in the second expected heat map; and
generating the second expected heat map according to the determined coordinates of the key points in the second expected heat map.

8. The method of claim 6, further comprising:
acquiring an initial image, key points in the initial image being annotated;
acquiring an input size required by the key point detection model;
performing scaling processing on the initial image to obtain the sample image with the input size; and
determining products of a quotient of dividing the input size by the size of the initial image and coordinates of the key points in the initial image as coordinates of the key points in the sample image.

9. The method of claim 1, further comprising:
determining a target pixel with the greatest heat value in the target heat map;
determining, according to coordinates of the target pixel in the target heat map and distribution statistics of the target heat map at the target pixel, potential peak coordinates in the target heat map; and
determining, according to products of a quotient of dividing a size of the image to be recognized by a size of the target heat map and the potential peak coordinates, coordinates of the key points in the image to be recognized.

10. An electronic device, comprising:
a memory configured to store a program; and
one or more processors coupled to the memory and configured to execute the program stored in the memory to cause the electronic device to perform:
acquiring a sample image and a first expected heat map of a first size and a second expected heat map of a second size corresponding to key points in the sample image, the first size being smaller than the second size;
inputting the sample image to a key point detection model to obtain a target predicted heat map corresponding to the key points in the sample image output by the key point detection model; wherein the key point detection model is configured to determine a first predicted heat map of the first size and a second predicted heat map of the second size corresponding to the key points in the sample image and configured to correct the second predicted heat map according to the first predicted heat map to obtain the target predicted heat map; and
optimizing the key point detection model according to a difference between the first predicted heat map and the first expected heat map and a difference between the target predicted heat map and the second expected heat map.

11. The electronic device of claim 10, wherein the one or more processors are configured to execute the program to cause the electronic device to further perform:
determining products of a quotient of dividing the first size by a size of the sample image and coordinates of the key points in the sample image as coordinates of the key points in the first expected heat map;
generating the first expected heat map according to the determined coordinates of the key points in the first expected heat map;
determining products of a quotient of dividing the second size by the size of the sample image and the coordinates of the key points in the sample image as coordinates of the key points in the second expected heat map; and
generating the second expected heat map according to the determined coordinates of the key points in the second expected heat map.

12. A non-transitory computer-readable storage medium storing a set of instructions that are executable by one or more processors of a device to cause the device to perform a method for key point detection, the method comprising:
acquiring an image to be recognized; and
inputting the image to be recognized into a trained key point detection model to obtain a target heat map output by the key point detection model, the target heat map corresponding to key points in the image to be recognized;
wherein the key point detection model is configured to: determine a first heat map of a first size and a second heat map of a second size corresponding to the key points in the image to be recognized; and correct the second heat map according to the first heat map to obtain the target heat map, the first size being smaller than the second size.

13. The non-transitory computer-readable storage medium of claim 12, wherein the set of instructions are executable by the one or more processors of the device to cause the device to further perform to determine the first heat map of the first size and the second heat map of the second size corresponding to the key points in the image to be recognized by:
performing feature extraction on the image to be recognized to obtain a first feature map of the first size;
determining, according to the first feature map, the first heat map of the first size corresponding to the key points in the image to be recognized;
performing transposed convolution on the first feature map to obtain a second feature map of the second size; and
determining the second heat map of the second size according to the second feature map.

14. The non-transitory computer-readable storage medium of claim 12, wherein the set of instructions are executable by the one or more processors of the device to cause the device to further perform to correct the second heat map according to the first heat map to obtain the target heat map by:
performing linear interpolation on the first heat map to obtain an interpolated heat map of the second size; and
correcting the second heat map according to the interpolated heat map to obtain the target heat map.

15. The non-transitory computer-readable storage medium of claim 14, wherein the set of instructions are executable by the one or more processors of the device to cause the device to further perform to correct the second heat map according to the interpolated heat map to obtain the target heat map by:
performing element-wise multiplication to the interpolated heat map and the second heat map to obtain a multiplied heat map; and
determining the target heat map according to the multiplied heat map.

16. The non-transitory computer-readable storage medium of claim 12, wherein the set of instructions are executable by the one or more processors of the device to cause the device to further perform:
acquiring a sample image and a first expected heat map of the first size and a second expected heat map of the second size corresponding to key points in the sample image;
inputting the sample image to the key point detection model to obtain a target predicted heat map output by the key point detection model, the target predicted heat map corresponding to the key points in the sample image; wherein the key point detection model is configured to determine a first predicted heat map of the first size and a second predicted heat map of the second size corresponding to the key points in the sample image, and configured to correct the second predicted heat map according to the first predicted heat map to obtain the target predicted heat map, wherein the key point detection model is a machine learning model; and
optimizing the key point detection model according to a difference between the first predicted heat map and the first expected heat map and a difference between the target predicted heat map and the second expected heat map.

17. The non-transitory computer-readable storage medium of claim 16, wherein the set of instructions are executable by the one or more processors of the device to cause the device to further perform:
determining products of a quotient of dividing the first size by a size of the sample image and coordinates of the key points in the sample image as coordinates of the key points in the first expected heat map; and
generating the first expected heat map according to the determined coordinates of the key points in the first expected heat map.

18. The non-transitory computer-readable storage medium of claim 17, wherein the set of instructions are executable by the one or more processors of the device to cause the device to further perform:
determining products of a quotient of dividing the second size by the size of the sample image and the coordinates of the key points in the sample image as coordinates of the key points in the second expected heat map; and
generating the second expected heat map according to the determined coordinates of the key points in the second expected heat map.

19. The non-transitory computer-readable storage medium of claim 17, wherein the set of instructions are executable by the one or more processors of the device to cause the device to further perform:
acquiring an initial image, key points in the initial image being annotated;
acquiring an input size required by the key point detection model;
performing scaling processing on the initial image to obtain the sample image with the input size; and
determining products of a quotient of dividing the input size by the size of the initial image and coordinates of the key points in the initial image as coordinates of the key points in the sample image.

20. The non-transitory computer-readable storage medium of claim 12, wherein the set of instructions are executable by the one or more processors of the device to cause the device to further perform:
determining a target pixel with the greatest heat value in the target heat map;
determining, according to coordinates of the target pixel in the target heat map and distribution statistics of the target heat map at the target pixel, potential peak coordinates in the target heat map; and
determining, according to products of a quotient of dividing a size of the image to be recognized by a size of the target heat map and the potential peak coordinates, coordinates of the key points in the image to be recognized.
